(19) United States
(12) Patent Application Publication
(10) Pub. No.: US 2026/0202048 A1
(43) Pub. Date: Jul. 16, 2026

(54) LIGHTING DEVICE AND LAMP BASE FOR USE IN LIGHTING DEVICE

(71) Applicant: SAVANT TECHNOLOGIES LLC, East Cleveland, OH (US)

(72) Inventors: Kun XIAO, Shanghai (CN); Jie GAO, Shanghai (CN); Hai HUANG, Shanghai (CN)

(73) Assignee: SAVANT TECHNOLOGIES LLC, East Cleveland, OH (US)

(21) Appl. No.: 19/405,471

(22) Filed: Dec. 2, 2025

(30) Foreign Application Priority Data
Dec. 2, 2024 (CN) 2024229599636

(51) Int. Cl. F21V 23/04; F21K 9/232; F21K 9/238; F21V 23/06; F21W 121/00; F21Y 115/10; H05B 45/10; H05B 45/20

(52) U.S. Cl. CPC F21V 23/04; F21K 9/232; F21K 9/238; F21V 23/06; H05B 45/10; H05B 45/20; F21W 2121/00; F21Y 2115/10

(57) ABSTRACT

Provided is a lighting device and a lamp base for use in the lighting device that includes a bulb housing connected to a lamp base and a light source accommodated inside the bulb housing. The lamp base has a metal thread portion electrically connected to an external circuit, an accommodating portion having a lower end, an upper end, and a side wall between the lower end and the upper end defining an accommodating space with the side wall, and switches connected to the light source for adjusting lighting parameters of the light source are in the accommodating space and an opening is provided on the side wall of the accommodating portion, allowing the switch to be controlled from the outside through the opening.

### CROSS-REFERENCE TO RELATED APPLICATIONS

This application claims priority to Chinese Patent Application Serial Number 202422959963.6, filed Dec. 2, 2024, which is herein incorporated by reference.

### TECHNICAL FIELD

The present disclosure relates to the field of lighting, and in particular to a lighting device for improving a lamp base.

### BACKGROUND

In the prior art, the size of a lamp base electrically connected to an external circuit of a lamp is relatively small, so that a driver and a switch of the lamp cannot be located on the lamp base, but are located on a bulb housing of the lamp, which is connected to the lamp base above the lamp base, and as a result, the appearance of the lamp is not aesthetically pleasing, and the lamp cannot be used for decorative purposes. In addition, existing lamps cannot realize multi-gear adjustment of the correlated color temperature (CCT) or wattage of the light source by means of switches.

In order to solve the problems of poor appearance and inconvenience in use of the lamp in the prior art, the lamp base of the lamp is improved in the present disclosure.

### SUMMARY OF THE INVENTION

The present disclosure aims to solve the problems in the prior art that the lamp is not aesthetically pleasing and multi-gear adjustment of lighting parameters cannot be achieved by means of switches.

By means of the design of the present disclosure, the lamp base of the present disclosure and a lighting device using the lamp base are not only aesthetically pleasing, but also significantly improve the convenience of use.

According to an aspect of the present disclosure, provided is a lamp base for use in a lighting device, the lighting device comprises a bulb housing connected to a lamp base and a light source accommodated inside the bulb housing. The lamp base comprises a metal thread portion, the metal thread portion having an external circuit connection end electrically connected to an external circuit, and an internal circuit connection end on the opposite side of the external circuit connection end; an accommodating portion, comprising a lower end, an upper end, and a side wall between the lower end and the upper end, wherein the lower end and the upper end define an accommodating space with the side wall, the lower end is integrally formed with the internal circuit connection end of the metal thread portion, the upper end is connected to the bulb housing of the lighting device, and switches connected to the light source and used for adjusting lighting parameters of the light source are accommodated in the accommodating space; and an opening further provided on the side wall of the accommodating portion, allowing the switch to be controlled from the outside through the opening.

In this way, in the present disclosure, an accommodating portion is provided at an upper portion of a metal thread portion of a lamp base to accommodate components such as a switch for adjusting lighting parameters of a light source, and a driver for controlling light emission of the light source, thereby preventing components such as the switch and the driver from being provided on the bulb housing of the lighting device. The improvement greatly improves the aesthetics of the lighting device. In addition, by providing the opening on the side wall of the accommodating portion, the present disclosure makes it possible to directly control the switch from the outside of the side wall. The improvement greatly improves the convenience in use of the lighting device.

According to an exemplary embodiment of the present disclosure, the number of switches is the same as the number of types of lighting parameters, and the number of openings is the same as the number of switches.

According to an exemplary embodiment of the present disclosure, the types of lighting parameters include CCT, wattage, or both.

In this way, when the type of the lighting parameters is the CCT, only one opening is provided on the side wall of the accommodating portion, and one switch inside the accommodating portion protrudes from the opening to the outside, so that the CCT of the light source can be adjusted from the outside. When the type of the lighting parameters is wattage, one switch inside the accommodating portion protrudes from the opening to the outside, so that the wattage of the light source can be adjusted from the outside, i.e. adjusting the brightness of the light source. When the type of the lighting parameters is both the CCT and the wattage, two openings are provided on the side wall of the accommodating portion, and two switches inside the accommodating portion respectively protrude from the two openings to the outside, so that the CCT and the wattage of the light source are simultaneously adjusted from the outside.

According to an exemplary embodiment of the present disclosure, each switch has a plurality of gears to perform multi-gear adjustment on each type of lighting parameters.

In this way, the present disclosure can achieve the technical effect of performing multi-gear adjustment of lighting parameters, thereby improving the use convenience and practicability of the lighting device.

According to an exemplary embodiment of the present disclosure, a driver electrically connected to the light source and used for controlling light emission of the light source is further accommodated in the accommodating space.

In this way, in the present disclosure, the driver is accommodated in the accommodating portion of the lamp base, and the driver is prevented from being provided on the bulb housing, thereby improving the aesthetic appearance of the lighting device.

According to an exemplary embodiment of the present disclosure, the thread of the metal thread portion of the lamp base comprise a E12 thread or a E17 thread.

According to an exemplary embodiment of the present disclosure, between an inner portion of the side wall of the accommodating portion and the driver, an inner insulator covers the inner portion, and the height of an upper edge of the inner insulator is lower than that of the side wall.

In this way, by providing the inner insulator between the inner portion of the side wall and the driver, the present disclosure avoids a short circuit of the driver circuit, reduces a circuit fault of the lighting device, and improves the durability and practicality of the lighting device.

According to an exemplary embodiment of the present disclosure, an outer insulator surrounding an outer portion of the side wall covers the outer portion of the side wall of the accommodating portion.

In this way, by covering the outer portion of the sidewall other than the opening with the outer insulator, the present disclosure can improve the overall reliability of the lamp base, enhance the insulation and pressure resistance, ensure the stable operation of the lamp base in various environments, and avoid the risk of electric shock when the lamp is screwed and unscrewed.

According to another aspect of the present disclosure, provided is a lighting device, comprising a bulb housing, containing a glass material and accommodating therein a light source; and the described lamp base.

In this way, the present disclosure provides a lighting device capable of improving the aesthetic appearance and the convenience of use.

According to an exemplary embodiment of the present disclosure, the light source is a filament light source.

According to an exemplary embodiment of the present disclosure, the lighting device is a decorative lamp.

According to another aspect of the present disclosure, provided is a lighting device having a metal lamp base, an insulating bulb housing, a drive circuit and a light source, one end of the metal lamp base being an external connection end connected to an external power source, and the other end being an internal connection end connected to the insulating bulb housing, a space for accommodating the drive circuit being formed inside the metal lamp base, and a space for accommodating the light source being formed inside the insulating bulb housing; a switch for controlling the drive circuit and the light source is provided inside the metal lamp base; and an opening is further formed on the side wall of the metal lamp base, allowing the switch to be controlled from the outside through the opening.

According to an exemplary embodiment of the present disclosure, the switch has different gears, and the different gears respectively control at least one of the color temperature, brightness and color of the light source, or a combination thereof.

According to an exemplary embodiment of the present disclosure, the bulb housing is made of glass, an inner insulator is further provided between the metal lamp base and the drive circuit, and an outer insulator is further provided outside the metal lamp base.

According to an exemplary embodiment of the present disclosure, the light source is of a filament structure, different filaments correspond to different electrical properties, the metal lamp base has a thread, and the thread comprises an E12 thread or an E17 thread.

The embodiments of the present disclosure provide a technical solution of improving the lamp base to accommodate components such as a driver and a switch, and providing an opening on the outer wall of the lamp base to control the switch from the outside, so as to adjust the lighting parameters of the lighting device, thereby at least solving the technical problems in the prior art that the appearance of the lamp base is not aesthetically pleasing, and the use convenience is relatively low during lighting parameter adjustment, and achieving the technical effect of improving the aesthetic sense and the use convenience.

### BRIEF DESCRIPTION OF THE DRAWINGS

Drawings described herein are used to provide a further understanding of the utility model and constitute a part of the application. The exemplary embodiments of the application and the description thereof are used to explain the application, but do not constitute improper limitations to the application. In the drawings:

FIG. 1 is an overall schematic diagram illustrating a lighting device including an improved lamp base according to the present disclosure.

FIG. 2 is an exploded view illustrating a lamp base according to the present disclosure.

### DETAILED DESCRIPTION

Hereinafter, the embodiments of the present disclosure will be described in detail with reference to the accompanying drawings, so that those skilled in the art can easily implement the embodiments of the present disclosure. However, the present application may be implemented in many different forms, and should not be construed as limited to the embodiments described herein. In the drawings, parts irrelevant to the description of the present application will be omitted for clarity. The similar reference numerals refer to similar elements throughout the description. In addition, when the description with reference to the drawings is provided, although elements are denoted by the same numerals, the reference numerals referring to the elements may be changed, and the reference numerals are described only for convenience of description, and it should not be understood that the concept, features, functions or effects of the elements are limited by the reference numerals.

In the prior art, the limitation on the size of the lamp base causes that the driver and the switch cannot be located on the lamp base, but are located on the bulb housing, which affects the appearance and aesthetics of the design of the lamp. To solve this problem, the present disclosure proposes an improved lamp base, which allows components such as a driver and a switch on the lamp bulb to be accommodated in the lamp base. In addition, in the present disclosure, the lamp base is provided with an opening to externally control components such as a switch and a driver, thereby improving the use convenience of the lighting device.

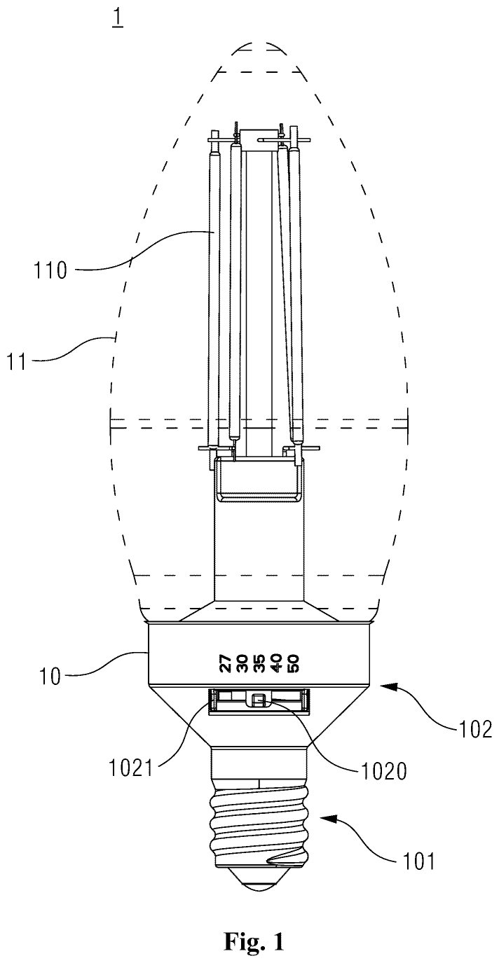

FIG. 1 is an overall schematic diagram illustrating a lighting device including an improved lamp base according to the present disclosure.

As shown in FIG. 1, the lighting device 1 includes a bulb housing 11 and a lamp base 10 connected to the bulb housing 11. The lighting device 1 may include various application types, such as indoor lighting, outdoor lighting, industrial lighting, special-purpose lighting and decorative lighting. The lighting device 1 is a decorative lamp in the present disclosure. The lamp base 10 is a tail end of the lamp and is a connection portion between a light source and an external power source. The main function of the lamp base 10 is to provide an electrical connection for the lamp, so as to ensure that a current can flow through the lamp safely and effectively, so that the light source 110 of the lamp emits light. The lamp base 10 is connected by means of riveting, locking and plugging, and the electric wire is connected to the lamp base 10 in different manners.

In the present disclosure, the lighting device 1 is a filament LED lamp, and has high brightness, high light efficiency, high color rendering index and high reliability. The filament LED lamp uses a semiconductor material; when a current passes through an LED chip, electrons and openings are recombined in the semiconductor material; and photons are directly generated to emit light. This process is referred to as electroluminescence, which directly converts electric energy into light energy, and has almost no generation of heat energy, thus having a higher efficiency.

The bulb housing 11 is located outside the filament LED lamp and is a part forming a lamp main body. A light source 110 is accommodated inside the bulb housing 11, and the light source 110 is an LED filament. The bulb housing 11 is made of heat-resistant glass, and is designed in a spherical shape or other shapes to adapt to different lighting requirements and aesthetic designs. The air is evacuated from the inside of the bulb housing 11 to form a vacuum state, so as to reduce the oxidation of the filament, or to further charge inert gas (such as argon) to reduce the heating and sublimation of the tungsten filament. The bulb housing 11 protects the internal LED filament from external physical damage, and also prevents oxygen and moisture in the external environment from causing oxidization or other chemical reactions on the filament. The material of the bulb housing has good light transmittance, ensuring that light can effectively penetrate and diffuse, and providing a uniform lighting effect. The bulb housing 11 participates in the heat dissipation process of the lamp, and uses convection and radiation to dissipate heat generated during operation of the lamp, so as to ensure a normal operating temperature of the lamp. The shape and color design of the bulb housing 11 enhances the aesthetic appearance of the bulb housing, so that the bulb housing can adapt to different decorative styles and lighting requirements.

In the present disclosure, the lamp base 10 also includes a metal thread portion 101 and an accommodating portion 102. The metal thread portion 101 has an external circuit connection end electrically connected to an external circuit, and an internal circuit connection end on the opposite side of the external circuit connection end; Specifically, the metal thread in the external circuit connection end is connected to the null wire of the external circuit, and the central protruding portion at the bottom is connected to the live wire of the external circuit, thereby ensuring that the current from the external circuit enables the lamp to emit light.

In other embodiments, the lamp base 10 may also be a bayonet lamp base, and is not limited to a threaded lamp base.

The accommodating portion 102 comprises a lower end, an upper end, and a side wall between the lower end and the upper end, wherein the lower end and the upper end define an accommodating space with the side wall, the lower end is integrally formed with the internal circuit connection end of the metal thread portion, the upper end is connected to the bulb housing 11 of the lighting device 1, and switches 1020 connected to the light source and used for adjusting lighting parameters of the light source are accommodated in the accommodating space; and
an opening 1021 further provided on the side wall of the accommodating portion 102, allowing the switch 1020 to be controlled from the outside through the opening 1021.

The switch 1020 is a mechanical dimmer switch, and for example, is of a knob type switch that is adjusted by a rotary knob, or of a toggle type switch that is adjusted by toggling gears. The switch 1020 can adjust a current passing through the lamp by changing the resistance value in the circuit or by sending different instructions to a chip provided on the drive circuit, so as to adjust other electrical parameters (e.g., duty cycle), thereby changing the brightness of the lamp, i.e., adjusting the wattage of the lamp. The wattage is a unit for measuring power. The wattage is widely applied, and can be used to measure the power consumption of various devices.

The switch 1020 may be used in a lamp including multiple groups of LEDs, for example, a group of LEDs with a color temperature of 2700 K, a group of LEDs with a color temperature of 4000 K, and a group of LEDs with a color temperature of 5000 K. The switch can be switched between different color temperatures by switching between different gears, and can adjust the overall color temperature of the lamp.

Correlated Color Temperature (CCT) is an important parameter to describe the color characteristics of the light source. When the color of light emitted from the light source is compared to be consistent with the color of light radiated from the black body (e.g., platinum) at a certain temperature, the temperature of the black body is expressed as the color temperature of the light source, which is expressed as Kelvin. The unit of CCT is Kelvin (K), which does not directly measure the brightness of the lamp, but describes the temperature of the black body when the light color of the light source is the same as that of the black body. CCT generally ranges from about 2700 K (warm tone) to about 6500 K (cool tone). When the color temperature is around 3000 K, the light color is yellowish, giving a feeling of warmth to people; and when the color temperature is over 5000 K, the light color is bluish, giving a feeling of refreshment or coldness to people. Different color temperatures can affect people's moods and behaviors, and therefore it is very important to select a suitable color temperature in the lighting design. In practical applications, the selection of the CCT is critical for creating a particular atmosphere or meeting a particular requirement. For example, indoor lighting may require a low color temperature to engineer a friendly atmosphere, while an office or hospital may require a high color temperature to provide a clear visual environment. In addition, the choice of CCT is also crucial for photography and film making, to ensure the color quality of the photograph or film.

In an example, the switch 1020 protrudes from the opening 1021 to the outside, and an operator or the like may directly control the switch 1020 from the outside (for example, by means of a toggle form or a rotary form), so as to adjust the CCT or the wattage by means of the switch 1020.

In the present disclosure, the number of switches is the same as the number of types of lighting parameters, and the number of openings is the same as the number of switches. The types of lighting parameters include CCT, wattage, or both.

When the type of the lighting parameters is CCT, only one opening is provided on the side wall of the accommodating portion 102, and one switch inside the accommodating portion 102 protrudes from the opening 1021 to the outside, so that the CCT of the light source 110 can be adjusted from the outside. When the type of the lighting parameter is wattage, one switch inside the accommodating portion 102 protrudes from the opening 1021 to the outside, so that the wattage of the light source 110 can be adjusted from the outside, that is, the brightness of the light source is adjusted. When the type of the lighting parameter is both the CCT and the wattage, two openings 1021 are provided on the side wall of the accommodating portion 102, and two switches in the accommodating portion 102 respectively protrude out from the two openings 1021, so that the CCT and the wattage of the light source are adjusted simultaneously from the outside.

Each switch has a plurality of gears to perform multi-gear adjustment on each type of lighting parameters (brightness, color temperature, color, etc.). For example, the CCT may be set to three or five gears: 2700K, 4000K and 5000K. The plurality of gears of each switch can be set according to actual needs.

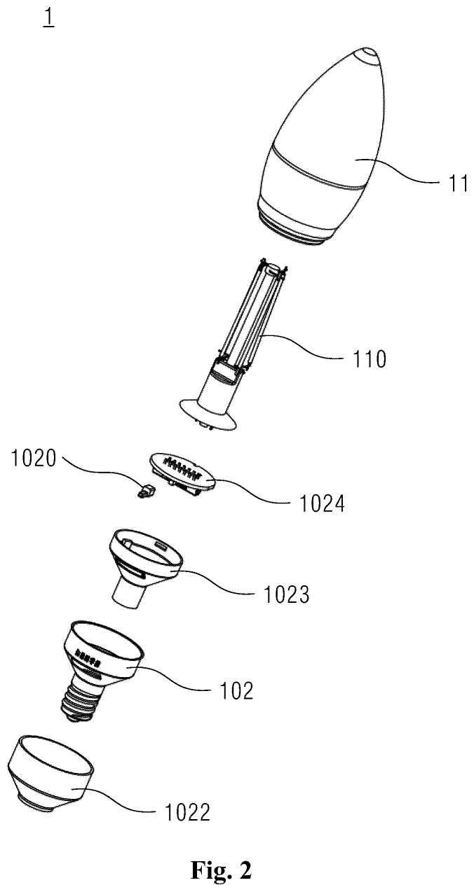

FIG. 2 is an exploded view illustrating a lamp base according to the present disclosure.

As shown in FIG. 2, a driver 1024 electrically connected to the light source and used for controlling light emission of the light source 110 is further accommodated in the accommodating space. For example, the driver 1024 is connected to the power source 110 by means of a wire.

Between an inner portion of the side wall of the accommodating portion 102 and the driver 1024, an inner insulator 1023 covers the inner portion, and the height of an upper edge of the inner insulator is lower than that of the side wall. In this case, the driver 1024 is stacked inside the inner insulator 1023. The switch 1020 is also stacked inside the inner insulator 1023.

The specific height difference between the inner insulator 1023 and the side wall can simplify the connection process of the lamp base 10. For example, the accommodating portion is embedded in the side wall by means of an injection molding process, making the connection at the joint more tighter, and reducing the complexity of the connection process; the height of the upper edge of the inner insulator 1023 is lower than that of the side wall, which helps to improve the structural stability of the whole lamp base 10. This design can provide better support and fixing, and reduce structural deformation caused by external force or thermal expansion; the design of the inner insulator 1023 may make mounting and maintenance of the lamp base 10 more convenient. For example, the inner insulator 1023 may act as a guide or positioning structure to help properly install drivers and other components. By means of the design of the inner insulator 1023, direct contact between electrical components can be reduced, thereby reducing the risk of a short circuit or an electrical fire, and improving the overall electrical safety.

An outer insulator 1022 surrounding an outer portion of the side wall covers the outer portion of the side wall of the accommodating portion 102.

The inner insulator 1023 and the outer insulator 1022 each are provided with an opening 1021 corresponding to the switch 1020 accommodated in the accommodating portion 102.

The connection between the bulb housing 11 and the upper end of the accommodating portion 102 of the lamp base 10 is an important link in the lamp structure, which is not only related to the electrical connection of the lamp, but also relates to the sealing performance and aesthetics of the lamp. The bulb housing 11 and the upper end of the accommodating portion 102 may be bonded, and the bulb housing 11 and the lamp base 10 may be fixed together by using, for example, a lamp base mud.

The embodiments of the present disclosure provide a technical solution of improving the lamp base to accommodate components such as a driver and a switch, and providing an opening on the outer wall of the lamp base to control the switch from the outside, so as to adjust the lighting parameters of the lighting device, thereby at least solving the technical problems in the prior art that the appearance of the lamp is not aesthetically pleasing, and the use convenience is relatively low during lighting parameter adjustment, and achieving the technical effect of improving the aesthetic sense and the use convenience.

The above exemplary embodiments have different emphases. Any missing details in one exemplary embodiment may be found in the related description of the other exemplary embodiments.

In the several embodiments provided in the present disclosure, it should be understood that the disclosed technical content may be implemented in other manners.

The description above only relate to preferred embodiments of the present disclosure. It should be noted that for a person with ordinary skill in the art, several improvements and modifications can also be made without departing from the technical principle of the present disclosure, and these improvements and modifications shall also be considered as within the scope of protection of the present disclosure.

1. A lamp base for use in a lighting device, having a bulb housing connected to the lamp base and a light source (110) accommodated inside the bulb housing, wherein the lamp base comprises:
a metal thread portion having an external circuit connection end electrically connected to an external circuit, and an internal circuit connection end on the opposite side of the external circuit connection end;
an accommodating portion, comprising a lower end, an upper end, and a side wall between the lower end and the upper end, wherein the lower end and the upper end define an accommodating space with the side wall, the lower end is integrally formed with the internal circuit connection end of the metal thread portion, the upper end is connected to the bulb housing of the lighting device, and switches connected to the light source and used for adjusting lighting parameters of the light source are accommodated in the accommodating space; and
an opening further provided on the side wall of the accommodating portion, allowing the switch to be controlled from the outside through the opening.

2. The lamp base according to claim 1, wherein the number of switches is the same as the number of types of adjustable lighting parameters, and the number of openings is the same as the number of switches.

3. The lamp base according to claim 2, wherein the types of lighting parameters comprise correlated color temperature (CCT), wattage, or both.

4. The lamp base according to claim 1, wherein each switch has a plurality of gears for multi-gear adjustment of each type of lighting parameter.

5. The lamp base according to claim 1, wherein a driver electrically connected to the light source for controlling light emission of the light source is further accommodated in the accommodating space.

6. The lamp base according to claim 1, wherein the screw thread of the metal thread portion of the lamp base comprises an E12 thread or an E17 thread.

7. The lamp base according to claim 5, wherein between an inner portion of the side wall of the accommodating portion and the driver, an inner insulator covers the inner portion, and the height of an upper edge of the inner insulator is lower than that of the side wall.

8. The lamp base according to claim 6, wherein an outer insulator surrounding an outer portion of the side wall covers the outer portion of the side wall of the accommodating portion.

9. A lighting device, comprising:
a bulb housing, containing a glass material and accommodating therein a light source; and
the lamp base according to claims 1.

10. The lighting device according to claim 9, wherein the light source is a filament light source.

11. The lighting device according to claim 9, wherein the lighting device is a decorative lamp.

12. A lighting device, wherein the lighting device is provided with a metal lamp base, an insulating bulb housing, a drive circuit and a light source,
one end of the metal lamp base being an external connection end connected to an external power source, and the other end being an internal connection end connected to the insulating bulb housing, a space for accommodating the drive circuit being formed inside the metal lamp base, and a space for accommodating the light source being formed inside the insulating bulb housing;
a switch for controlling the drive circuit and the light source is provided inside the metal lamp base; and an opening is further formed on the side wall of the metal lamp base, allowing the switch to be controlled from the outside through the opening.

13. The lighting device according to claim 12, wherein the switch has different gears, and the different gears respectively control at least one of the color temperature, brightness and color of the light source, or a combination thereof.

14. The lighting device according to claim 12, wherein the bulb housing is made of glass, an inner insulator is further provided between the metal lamp base and the drive circuit, and an outer insulator is further provided outside the metal lamp base.

15. The lighting device according to claim 12, wherein the light source is of a filament structure, different filaments correspond to different electrical properties, the metal lamp base has a thread, and the thread comprises an E12 thread or an E17 thread.
